(19) United States
(12) Patent Application Publication
(10) Pub. No.: US 2014/0096871 A1
(43) Pub. Date: Apr. 10, 2014

(54) METHOD, APPARATUS, AND SYSTEM FOR CONTROLLING A TIMBER-WORKING DEVICE

(71) Applicant: Waratah NZ Limited, Tokoroa (NZ)

(72) Inventor: Brett James Kaye, Tauranga (NZ)

(73) Assignee: Waratah NZ Limited, Tokoroa (NZ)

(21) Appl. No.: 14/049,939

(22) Filed: Oct. 9, 2013

(30) Foreign Application Priority Data
Oct. 10, 2012 (NZ) 602930

(51) Int. Cl. A01G 23/02; B27G 19/00

(52) U.S. Cl. CPC A01G 23/02; B27G 19/00
USPC 144/335; 144/420

(57) ABSTRACT

A method, apparatus, and system for operation of a timber-working device capable of performing an operation having an associated hazard zone. The device can receive a wireless signal indicating a location of an object tracking device, determine the location of the object tracking device relative to the hazard zone of the timber-working device and determine a recommended operation of the timber-working device based at least in part on the location of the object tracking device relative to the hazard zone.

This application claims priority to New Zealand Patent Application Number 602930 filed Oct. 10, 2012, the entire contents of which are incorporated herein by reference.

### FIELD OF THE DISCLOSURE

The present disclosure relates to a method, apparatus, and system for controlling a timber-working device.

### BACKGROUND OF THE DISCLOSURE

It is well-known to mount timber-working devices to a carrier vehicle in order to perform a number of operations in connection with timber processing. These operations may include one, or a combination of, grappling and felling a standing tree, delimbing a felled stem, debarking the stem, and cutting the stem into logs—commonly using at least one chainsaw.

A significant hazard associated with timber-working devices including a chainsaw is a phenomenon known as “chain shot”. Chain shot results from the saw chain breaking, following which parts from the chain or other portions of the saw assembly are propelled at high velocity from the harvester into the surrounding environment. Other types of saw, such as disc saws, may experience a similar phenomenon whereby the teeth of the saw are propelled from the saw.

Further, many timber-working devices include a drive or feed mechanism in the form of at least one driven roller—for example rollers mounted on grapple arms which grip the stem and control position of the stem relative to the device. The drive mechanism allows the stem to be moved relative to the timber-working device for debarking, delimbing, and cutting. In the course of doing so, the stem may be fed either forward or reverse through the device at upwards of 5 m/s.

It is known to use radio frequency identification (RFID) systems to identify the presence and location of personnel and equipment within a work environment, and controlling access to an area, or operation of equipment, based on the danger associated with the presence of personnel in the vicinity.

For example, U.S. Pat. No. 8,115,650 discloses a system by which the movement of a vehicle is controlled in response to the presence of workmen in proximity to the vehicle. This patent discloses that directional antennas may be used to spatially limit a danger zone in order to minimize the number of alarms being triggered because of workmen in proximity to a machine but who are not within the danger zone (within which the likelihood of physical collision is greatly increased).

### SUMMARY

According to one aspect of the present disclosure there is provided a method for operation of a timber-working device, the timber-working device configured to perform at least one operation having an associated hazard zone, the method including the steps of: receiving at least one wireless signal indicating a location of at least one object tracking device; determining the location of the object tracking device relative to the hazard zone of the timber-working device; and determining at least one recommended operation of the timber-working device based at least in part on the location of the object tracking device relative to the hazard zone.

According to another aspect of the present disclosure there is provided an apparatus for use with a timber-working device, the timber-working device configured to perform at least one operation having an associated hazard zone, the apparatus including: at least one processor configured to: receive at least one wireless signal indicating a location of at least one object tracking device; determine the location of the object tracking device relative to the hazard zone of the timber-working device; and determining at least one recommended operation of the timber-working device based at least in part on the location of the object tracking device relative to the hazard zone.

According to another aspect of the present disclosure there is provided a harvester system, including: a timber-working device configured to perform at least one operation having an associated hazard zone; at least one object tracking device configured to output a wireless signal indicating the location of the object tracking device; and at least one processor configured to: receive the wireless signal indicating a location of the object tracking device; determine the location of the object tracking device relative to the hazard zone of the timber-working device; determine at least one recommended operation of the timber-working device based at least in part on the location of the object tracking device relative to the hazard zone.

Further aspects of the present disclosure will become apparent from the following description which is given by way of example only and with reference to the accompanying drawings.

### BRIEF DESCRIPTION OF THE DRAWINGS

FIG. 1A is a side view of an example timber-working system including, for example, a harvester head according to one aspect of the present disclosure;

FIG. 1B is a diagrammatic view of an example control system for the timber-working system;

FIG. 2A is a side view of an example timber-working system including, for example, a harvester head showing an example hazard zone associated with the harvester head;

FIG. 2B is an elevated view of the timber-working system and associated hazard zones;

FIG. 3 is a flowchart illustrating an example method for operating a harvester head according to one aspect of the present disclosure;

FIG. 4 is an elevated view of an example hazard zone associated with a harvester head for processing a tree stem according to another aspect of the present disclosure;

FIG. 5 is an elevated view of another example hazard zone associated with a harvester head for processing a tree stem according to another aspect of the present disclosure, and

FIG. 6 is an elevated view of an example embodiment of proximity zones associated with a harvester head for processing a tree stem according to another aspect of the present disclosure.

### DETAILED DESCRIPTION

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

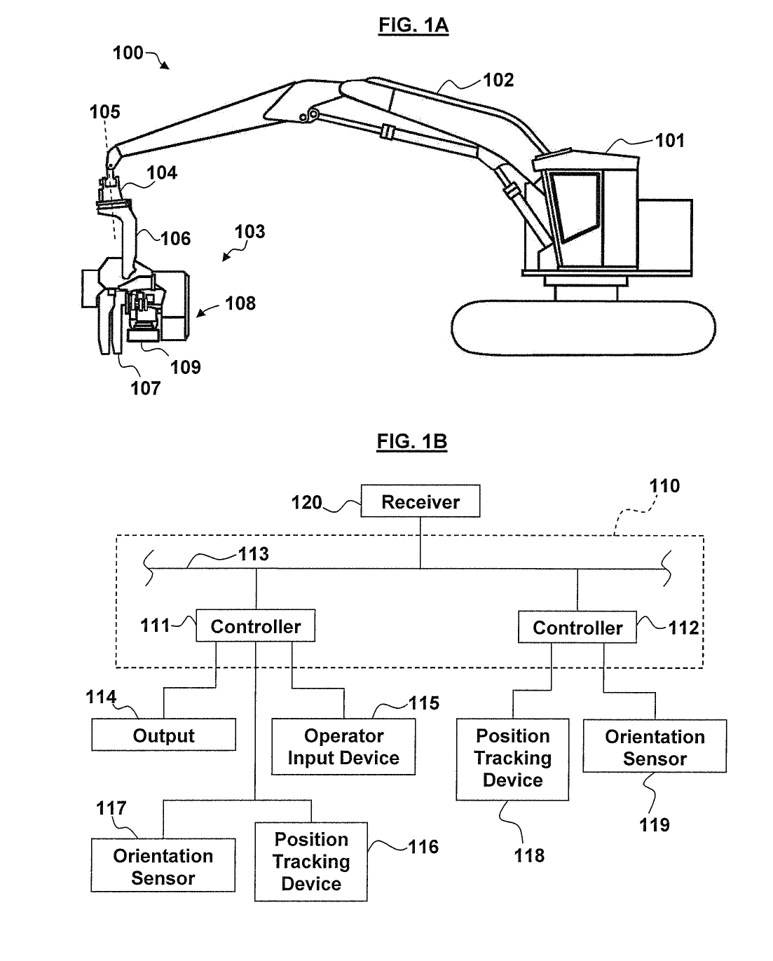

FIG. 1A illustrates a timber-working system including a carrier 100 for use in forest harvesting. The carrier 100 includes an operator cab 101 from which an operator (not shown) controls the carrier 100.

The carrier 100 further includes an articulated arm 102, to which a timber-working device in the form of a harvester head 103 is connected. Connection of the harvester head 103 to the arm 102 includes a rotator 104, configured to rotate the harvester head about the generally vertical axis of rotation marked by dashed line 105. A tilt bracket 106 further allows rotation of the harvester head 103 between a prone position (as illustrated) and a standing position.

The harvester head 103 includes grapple or delimbing arms 107 configured to grasp the stem of a tree (not illustrated), at least one chainsaw at the end marked by arrow 108, and at least one feed roller 109 configured to control the position of the tree relative to the chainsaw 108.

Referring to FIG. 1B, the carrier 100 and harvester head 103 are controlled by an electronic control system 110. The control system 110 includes one or more electronic controllers, each controller including a processor and memory having stored therein instructions which, when executed by the processor, causes the processor to perform the various operations of the controller.

For example, the control system 110 includes a first controller 111 on board the carrier 100 and a second controller 112 on board the head 103. The controllers 111, 112 are connected to one another via a communications bus 113 (e.g., a CAN bus).

A human operator operates an operator input device 114 located at the operator's cab 101 of the carrier 100 to control the head 103. Details of operation are output to an output device 114—for example a monitor. Certain automated functions may be controlled by first controller 111 and/or second controller 112.

A first position tracking device in the form of a first GPS transponder 116 is associated with the carrier 100 and electronically connected to first controller 111. The GPS transponder 116 has an associated unique identifier identifying the carrier 100. Further, the carrier 100 includes an orientation sensor, for example first compass 117, electronically connected to the first controller 111.

The head 103 also includes a position tracking device in the form of a second GPS transponder 118, electronically connected to second controller 112. The GPS transponder 118 has an associated unique identifier identifying the head 100 and hazard zones associated with operation of the head (as will be discussed further below).

Further, the head 103 includes an orientation sensor, for example second compass 119, electronically connected to the second controller 112. Alternatively, the orientation sensor could be a rotation sensor associated with rotator 104—which together with the first compass 117 could be used to determine orientation of the head 103 relative to a cardinal direction.

The control system 110 is configured to receive signals from other GPS transponders in the vicinity via receiver 120, and process their positions relative to the carrier 100 and head 103 as discussed below.

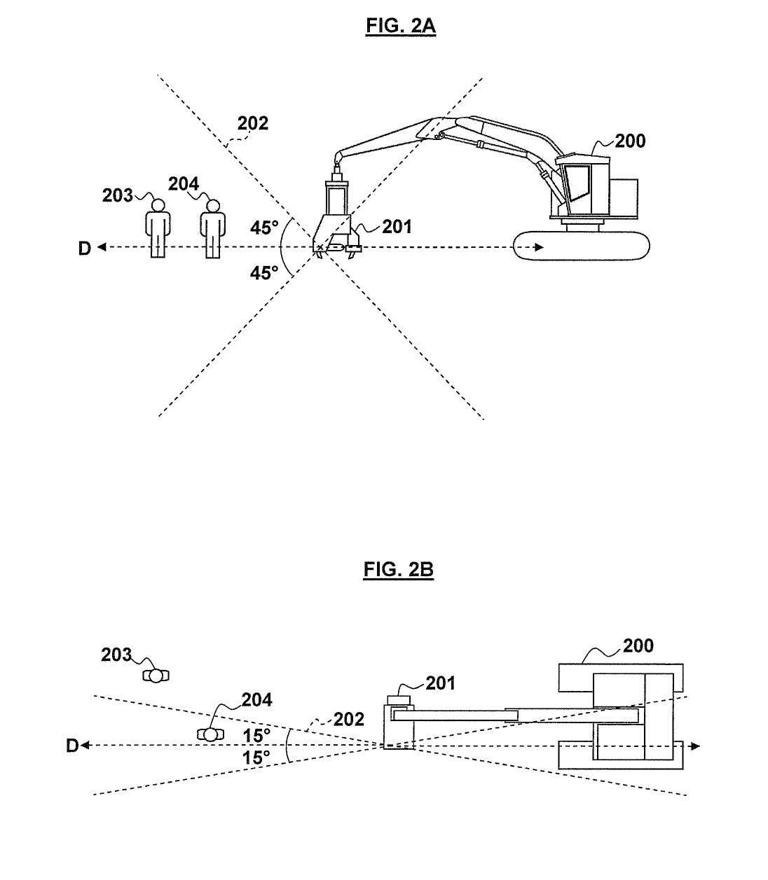

FIG. 2A and FIG. 2B illustrate a harvester carrier 200 for a harvester head 201, generally configured in the manner described with reference to FIG. 1A and FIG. 1B.

The harvester head 201 includes a chainsaw (not clearly illustrated) as known in the art. The harvester head 201 has a saw hazard zone indicated by dashed lines 202 centred about the saw drive gear.

As seen in FIG. 2A, the saw hazard zone 202 extends through substantially 90° in the plane aligning with the cutting plane of the saw bar. Referring to FIG. 2B, the saw hazard zone 202 may extend through substantially 30° in the plane substantially perpendicular to the cutting plane. It should be appreciated that the angles described herein are example, and not intended to be limiting.

The distance D to which the saw hazard zone 202 extends may be determined by the operating speed of the chainsaw, and characteristics of the chain such as pitch or gauge.

Two ground workers 203 and 204, each having a GPS transponder, are illustrated in FIG. 2A and FIG. 2B. In FIG. 2A, it may be seen that both workers are within the vertical element of the saw hazard zone 202, while in FIG. 2B only the second worker 204 is within the horizontal element of the saw hazard zone 202.

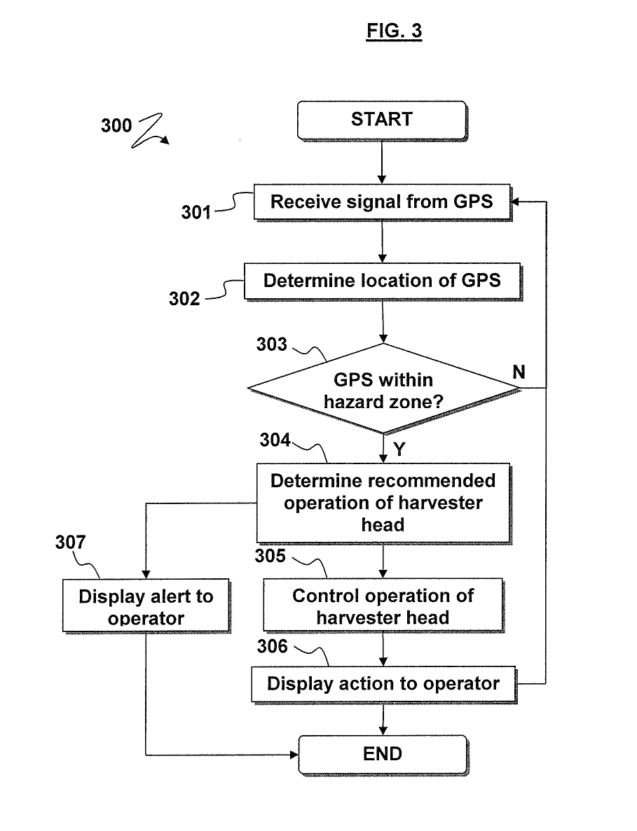

FIG. 3 illustrates a method 300 for operating a harvester head. The methods steps will be described with reference to FIG. 1B, FIG. 2A and FIG. 2B. In step 301 the first controller 111 receives location signals from GPS transponders associated with workers 203 and 204 via receiver 120, and determines the nature of the object associated with the transponders.

In step 302 the first controller 111 receives signals from the first GPS transponder 116, first compass 117, second GPS transponder 118, second compass 119 or rotation sensor associated with rotator 104. At step 303 the first controller 111 determines whether the workers 203 and 204 are within the saw hazard zone 202 associated with operation of the chainsaw using the current orientation of the harvester head and thus saw hazard zone 202. If so, as in the case of worker 204, in step 304 the first controller 111 looks up a recommended operation for the chainsaw given the presence of the second worker 204 within the saw hazard zone 202. A recommended operation for such a condition could be to disable operation of the chainsaw. It should be appreciated that in some embodiments, the position and orientation of the carrier 200 may not be required, as the location and orientation of the head 201 may be sufficient for determining whether a risk of injury is present.

In step 305 the first controller 111 transmits a signal to the second controller 112 to control operation of the harvester head 201 according to the recommended operation, stopping the chainsaw. In step 306 the execution of the recommended operation, and cause for same, is displayed to the operator of the harvester head 201. The operator may have the option to override the recommended operation—for example by selecting an override option on the display, or selecting the relevant control more than once (for example selecting the saw activation button twice). Alternatively to steps 305 and 306, following step 305 the first controller 111 may transmit an alert to the operator via monitor 114 warning them of the presence of the worker and notifying them of the recommended operation in step 307.

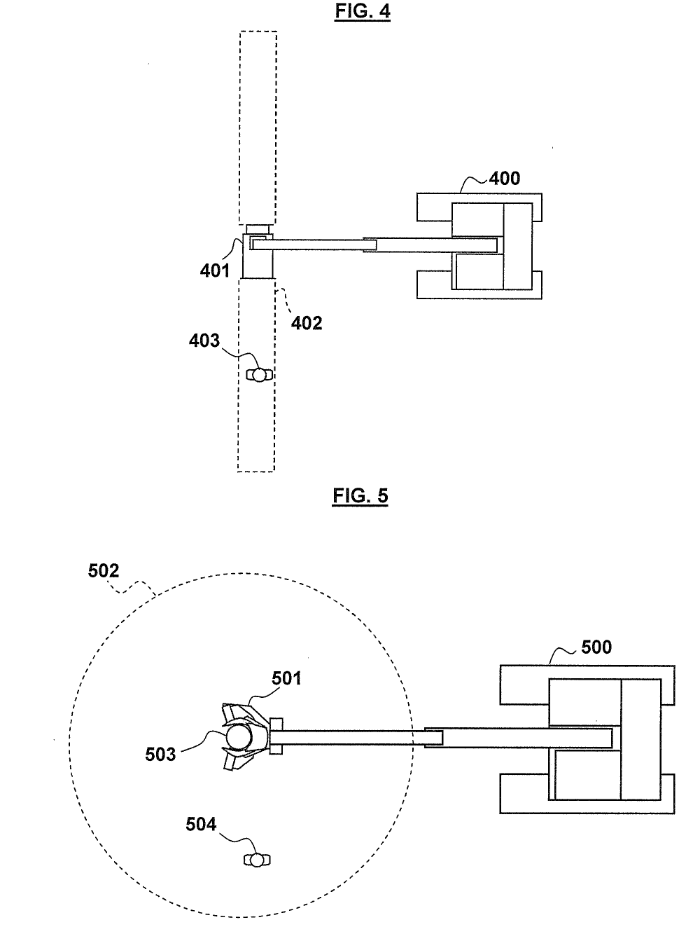

FIG. 4 illustrates a harvester carrier 400 for a harvester head 401. In this embodiment the hazard zone illustrated is a feed hazard zone indicated by dashed line 402. The feed hazard zone 402 represents the space within which a stem may be driven by the drive mechanism of the harvester head 401. In the scenario illustrated, a similar process to that illustrated by FIG. 3 may be undertaken to find that worker 403 would be within the feed hazard zone 402—and drive operation of the harvester head 401 disabled.

FIG. 5 illustrates a harvester carrier 500 for a harvester head 501. In this embodiment the hazard zone illustrated is a felling hazard zone indicated by dashed line 502. The feed hazard zone 502 represents the space within which a standing tree 503 may fall, having been cut by the cutting tool of the harvester head 501. In the scenario illustrated, a similar process to that illustrated by FIG. 3 may be undertaken to find that worker 504 would be within the felling hazard zone 502—and cutting operation of the harvester head 501 disabled.

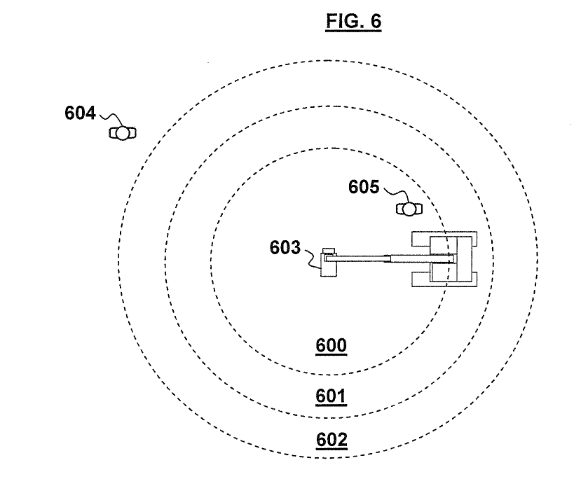

FIG. 6 illustrates an embodiment of the present disclosure in which a series of concentric proximity zones 600, 601, and 602 are centred about a harvester head 603. Each proximity zone has an associated hazard rating, increasing with proximity to the harvester head 603. A first ground worker 604 is illustrated outside the proximity zones, with a second ground worker 605 within the first proximity zone 600.

Referring to elements of FIG. 1B, the first controller 111 is configured to receive position signals from GPS transponders carried by each of the workers 604 and 605. The first controller 111 is configured to determine the location of the workers 604 and 605 relative to the harvester head 603.

On determining that a transponder is within one of the proximity zones, the first controller 111 may notify the operator of their location to ensure that the operator is aware of their presence. The hazard rating of the proximity zone may determine the manner in which this is displayed to the operator. For example, a small notification in the corner of the monitor 114 may be provided for worker 604, while the presence of worker 605 in the highest risk proximity zone may cause a more prominent notification to be issued.

This may be particularly useful in the scenario illustrated, where worker 605 may not be directly within a saw or feed hazard zone of the harvester head 603. The operator may take pre-emptive steps to ensure that the hazard zones do not intersect with the location of the worker 605 and disrupt operation. Further, or in place of the alert, the operator may be provided with a radar style overview of GPS transponders in the vicinity relative to the operator's position.

Reference to a hazard zone should be understood to mean a predetermined space within which a person or object is at risk of being injured or damaged by a particular operation of the timber-working device—whether due to regular operation of the timber-working device or malfunction of same.

In particular, the operation is envisaged as being one which extends beyond the physical dimensions of the timber-working device itself—as will be evident from the examples discussed further below.

In an embodiment the hazard zone may be determined based on the likely path of an object being propelled from the timber-working device due to at least one feature or operation of the device. For example, the object may be a tooth of a disk saw, or link of a chainsaw (as will be discussed further below).

In another embodiment, the hazard zone may be determined based on the likely path of an object extending from the timber-working device due to at least one feature or operation of the device. For example, the timber-working device may be the grapple of a skidder used to drag cut stems—where the hazard zone is the length of the stem extending from the grapple. The length of the stem used to determine the hazard zone may, for example, be the greatest length of stem cut by other timber-working devices in the area.

In another example, the timber-working device may be a swing yarder (also known as a grapple yarder). Swing yarder operation involves running a grapple along a cable strung between two points, and lowering the grapple to grasp felled stems. Lowering of the grapple, and subsequent movement of the grapple carrying the stems, presents a hazard to personnel on the ground. The hazard zone may be associated with such a system may be the space directly below the grapple, and/or the length of the stem extending from the grapple once engaged.

The timber-working device can be a harvester head, and may be referred to as such throughout the specification. Harvester heads typically have the capacity to grapple and fell a standing tree, delimb and/or debark a felled stem, and cut the stem into logs. For ease of understanding, reference will herein be made to the timber-working device being a harvester head. However, a person skilled in the art should appreciate that the present disclosure may be used with other timber-working devices, for example a feller buncher, debarking and/or delimbing head, disc saw head, saw grapple, swing yarder, and so on.

In an embodiment the harvester head includes a cutting tool configured to cut through the stem. The cutting tool can include at least one saw. In particular it is envisaged that the present disclosure may have particular application to timber-working devices including at least one chainsaw. However, this is not intended to be limiting as the saw may take other forms—for example a disc saw.

Harvester heads may include a main saw which is primarily used for the felling and cross cutting of stems. Further, some timber working heads may include a secondary or topping saw. The topping saw is typically of a lower specification than the main saw, and used primarily during processing once a tree is felled.

Each chainsaw may include a saw chain, a saw bar around which the saw chain moves, and a saw drive gear for driving the saw chain around the saw bar.

In an embodiment at least one hazard zone projects from the cutting tool. It is envisaged that the hazard zone may center about the saw drive gear, although it should be appreciated that this is not intended to be limiting. In an example embodiment wherein the cutting tool is a chainsaw, the hazard zone extends through the angle of rotation of the chainsaw about its pivot point in the plane aligning with the cutting plane of the cutting tool—i.e. the saw bar.

It should be appreciated that the hazard zone may take the structure of the timber-working device into account. For example, it is envisaged that the chainsaw of an example harvester head may rotate through a 93° angle, with the initial 5-7° contained within the harvester body. As such, the hazard zone may extend through the substantially 90° angle outside the body. Further, the hazard zone may extend through substantially 30° in the plane substantially lateral to the cutting plane. This angle is an industry standard with regard to chainsaws.

It should be appreciated that these angles are described by way of example only, and the hazard zone or zones implemented with the present disclosure may vary in light of various factors such as operating conditions, device configuration—for example saw speed, safety standards, organizational requirements and so on.

A hazard zone may project from either side of the cutting tool. This configuration may be particularly useful for defining the space within which chain shot may occur. In particular, such a hazard zone may define the area in which the greatest risk due to chain shot is present, while delimiting the space sufficiently to permit safe operation through as great a range of orientations as possible.

It should be appreciated that this definition of the hazard zone is not intended to be limiting, and that other configurations of the hazard zone or zones associated with the cutting tool may be used with the present disclosure.

In an embodiment recommended operation of the harvester head includes disabling operation of the cutting tool when the location of the object tracking device is within the at least one hazard zone associated with the cutting tool.

The harvester head can include a drive mechanism including at least one driven roller configured to control the position of a stem held by the harvester head relative to the harvester head.

In an embodiment at least one hazard zone projects in at least one direction in which a stem is configured to be driven by the drive mechanism.

In an embodiment recommended operation of the harvester head includes controlling the drive mechanism when the location of the object tracking device is within the at least one hazard zone associated with the drive mechanism.

Control of the drive mechanism may include adjusting the speed of the drive mechanism. Further, control of the drive mechanism may include disabling operation of the drive mechanism. Disabling operation of the drive mechanism may include limiting operation to be in one direction, for example away from the operator's cabin.

In one embodiment the hazard zone may be adjusted depending on the current configuration or operation of the harvester head. For example, where the speed of the drive mechanism is variable the hazard zone associated with the feed operation may vary in accordance with the current feed through speed.

In another embodiment, the harvester head may be configured to determine the diameter of the stem being processed, and the hazard zone may be adjusted depending on the measured diameter. It is envisaged that this adjustment of the hazard zone may be based on the physical dimensions of the stem such as width, or properties of the stem inferred from diameter such as mass. For example, stems with a greater mass may have a greater hazard area due to the greater momentum when feeding the stem using the drive mechanism. Further, the length of the stem may be projected from the measured diameter by comparing previous stem data for similar diameter trees (whether in a specific stand of trees, or forest in general.

In one embodiment the hazard zone may be adjusted depending on the length of the stem being processed by the harvester, whether measured or predicted. For example, with regard to the hazard zone or zones associated with the drive mechanism, the hazard zone may extend to at least the greatest length of the stem being processed.

In another example, a standing tree may have a hazard zone associated with felling—an area surrounding a tree to be felled. The recommended operation of the harvester may include disabling operation of the cutting tool when the location of the object tracking device is within the hazard zone surrounding the tree. The size of the hazard zone is determined, at least in part, on a measured diameter of the tree when the harvester is mounted to it.

The hazard zone may include a buffer zone extending beyond the length of the stem—whether a set distance or proportional to the length of the stem.

Reference to an object tracking device should be understood to mean any means by which a location relative to a base position may be determined. It should be appreciated that reference to location may mean proximity, direction, or a combination thereof. It should be appreciated that a number of technologies for achieving this are known. For example, the object tracking device may be a Radio Frequency Identification (RFID) tag, a Global Positioning System (GPS) locator, or Real-time Locating System (RTLS) tag. It should be appreciated that this is not intended to be limiting, and that other forms of object tracking device may be used with the present disclosure.

The system may include transmitters and receivers as known in the art in order to facilitate communication between the various components of the system. The location of the object tracking device relative to the hazard zone may be determined by any means known in the art. For example, the harvester head may include an object tracking device of its own.

In an embodiment, sensors may be used to determine movement of the head relative to its associated carrier vehicle, with the base position being a fixed position of the vehicle. For example, rotation sensors may be positioned on the rotator of the harvester head, as well at points of articulation or rotation on the carrier vehicle and vehicle arm. By combining the various sensor outputs, the current orientation of the harvester head and associated hazard areas relative to the base position and/or object tracking device may be determined.

In another embodiment, the head and/or carrier vehicle may include a compass to provide a frame of reference for orientation of the head and/or carrier vehicle.

It is envisaged that the object tracking device may be used to identify the nature of the object with which it is associated. For example, an object tracking device may identify whether the object is a person, or piece of equipment.

It should be appreciated that tracking devices may also be used to demarcate geographical features or infrastructure rather than objects as such—for example, cliffs, roads, or designated rest areas. Such areas may be “ring fenced” for protection—whether of the operator or people/equipment at those locations.

Control of the operation of the harvester head may be based at least on part on the type of object associated with the object tracking device. For example, if an object tracking device is identified as being associated with a container at a particular distance and within the hazard zone of a chainsaw, operation may be permitted to continue. In contrast, if the object was determined to be a person at the same distance, operation of the chainsaw may be stopped.

In an embodiment, control of the operation of the harvester head may be based at least on part on the position of one object tracking device relative to another object tracking device. For example, if a person is determined to be within a hazard zone, but a protective object (such as a container) is determined to be between the person and the harvester head operation of the harvester head may not be interrupted.

In an embodiment the location of the object tracking device may be used to determine proximity of the object tracking device to the harvester head.

In an embodiment the processor is configured to determine the location of the object tracking device relative to at least one proximity zone surrounding the harvester head.

It is envisaged that a plurality of concentric proximity zones may be provided, each proximity zone having an associated hazard rating. The hazard rating may be determined by a number of factors, for example the specifications of the harvester head and associated vehicle carrier, current operating characteristics of the harvester head, and/or safety requirements (whether based on local standards, or operator or site specific). For example, with regard to chain shot the presence of personnel or equipment within a proximity zone closer to the harvester head may have a greater hazard rating than an outer proximity zone.

As a further example, a person may be designated as being at a greater risk of being damaged due to chain shot within a particular proximity zone than a piece of equipment.

In an example embodiment the hazard rating of a proximity zone, and/or size of a proximity zone may be adjusted in response to inputs from the operator or timber working device itself. For example, the operator may recognize that the next tree to be felled is greater in length or mass than others in the vicinity, and input an indicator of increased risk likelihood into the controller during the course of processing that tree. Alternatively, the diameter measurement on attaching the device to the tree may trigger determination of increased risk likelihood and result in automatic adjustment.

Similarly, the operator may recognize that the gradient of the area on which they are operating requires a greater proximity zone than at present, and increase the risk likelihood. Alternatively, a level sensor on the carrier may be used to automatically determine this.

It should be appreciated that the processor may directly or indirectly cause operation of the harvester head to be controlled in response to the determined recommended operation. For example, the processor may be one dedicated to performance of the present disclosure and configured to communicate the recommended operation to a control module configured to control operation of the harvester head. Alternatively, the processor may be that of an existing control system.

In an embodiment the processor is configured to transmit notification of an object tracking device being within a hazard zone or proximity zone to an operator device. The operator device may be, for example, a display, a siren, a strobe light, or any other sensory alarm. It is envisaged that the notification may be transmitted to a display such as a touchscreen used by the operator to monitor and control operation of the harvester head, as the operator is likely to be observing such a display.

In one embodiment the notification may include the recommended operation of the harvester head. The system may be configured to allow an operator to authorize or override the recommended operation determined by the processor. For example, the operator may override the locking out of a chainsaw by performing a double selection of the saw activation button. Alternatively, the system may rely on the operator to manually perform the recommended operation. The notification may include a visual representation of the location of the object tracking device relative to the harvester head.

Typically, the vision of the operator of a harvester head is restricted to a certain degree by the structure of the cab from which they operate, and the carrier vehicle itself. By providing the notification of the object tracking device being within a hazard zone or proximity zone, the operator of the harvester may take precautions or actions in order to maintain a safe working environment—whether before or after a high risk hazard condition has occurred.

The various illustrative logical blocks, modules, circuits, and algorithm steps described in connection with the embodiments disclosed herein may be implemented as electronic hardware, computer software, or combinations of both. In particular, they may be implemented or performed with a general purpose processor such as a microprocessor, or any other suitable means known in the art designed to perform the functions described.

The steps of a method or algorithm and functions described in connection with the embodiments disclosed herein may be embodied directly in hardware, in a software module executed by a processor, or in a combination of the two. If implemented in software, the functions may be stored as processor readable instructions or code on a tangible, non-transitory processor-readable medium—for example Random Access Memory (RAM), flash memory, Read Only Memory (ROM), hard disks, a removable disk such as a CD ROM, or any other suitable storage medium known to a person skilled in the art. A storage medium may be connected to the processor such that the processor can read information from, and write information to, the storage medium.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

Aspects of the present disclosure have been described by way of example only and it should be appreciated that modifications and additions may be made thereto without departing from the scope thereof as defined in the appended claims.

1. A method for operation of a timber-working device, the timber-working device configured to perform at least one operation having an associated hazard zone, the method comprising the steps of:
receiving at least one wireless signal indicating a location of at least one object tracking device;
determining the location of the object tracking device relative to the hazard zone of the timber-working device; and
determining at least one recommended operation of the timber-working device based at least in part on the location of the object tracking device relative to the hazard zone.

2. The method of claim 1, wherein the hazard zone is determined based on the likely path of an object being propelled from the timber-working device.

3. The method of claim 1, wherein the recommended operation of the timber-working device includes disabling operation of a cutting tool when the location of the object tracking device is within the at least one hazard zone associated with a cutting tool.

4. The method of claim 1, wherein the recommended operation of the timber-working device includes controlling a drive mechanism when the location of the object tracking device is within the at least one hazard zone associated with the drive mechanism.

5. The method of claim 4, wherein controlling the drive mechanism includes adjusting the speed of the drive mechanism.

6. The method of claim 1, wherein the hazard zone is an area surrounding a tree to be felled, and wherein the recommended operation of the timber-working device includes disabling operation of a cutting tool when the location of the object tracking device is within the hazard zone surrounding the tree.

7. The method of claim 6, wherein the size of the hazard zone is determined, at least in part, on a measured diameter of the tree.

8. The method of claim 1, further comprising adjusting the at least one hazard zone based at least in part on the current configuration of the timber-working device.

9. The method of claim 1, wherein the wireless signal is used to identify the nature of an object with which the object tracking device is associated.

10. The method of claim 9, wherein the recommended operation of the timber-working device is based at least on part on the nature of the object associated with the object tracking device.

11. The method of claim 10, wherein the recommended operation of the timber-working device is based at least on part on the position of one object tracking device relative to another object tracking device.

12. The method of claim 11, further comprising determining the location of the object tracking device relative to at least one proximity zone surrounding the timber-working device.

13. The method of claim 12, wherein the at least one proximity zone includes a plurality of concentric proximity zones.

14. The method of claim 13, wherein each proximity zone has an associated hazard rating.

15. The method of claim 1, further comprising transmitting notification of an object tracking device being within a hazard zone to an operator device.

16. The method of claim 15, wherein the notification includes the recommended operation of the timber-working device.

17. The method of claim 1, further comprising controlling operation of the timber-working device according to the recommended operation.

18. An apparatus for use with a timber-working device, the timber-working device configured to perform at least one operation having an associated hazard zone, the apparatus comprising
at least one processor configured to:
receive at least one wireless signal indicating a location of at least one object tracking device;
determine the location of the object tracking device relative to the hazard zone of the timber-working device; and
determine recommended operation of the timber-working device based at least in part on the location of the object tracking device relative to the hazard zone.

19. The apparatus of claim 18, wherein the timber-working device includes a cutting tool configured to cut through a stem being processed by the timber-working device and the at least one hazard zone projects from the cutting tool.

20. The apparatus of claim 19, wherein the cutting tool includes at least one chainsaw.

21. The apparatus of claim 20, wherein the chainsaw includes a saw chain, a saw bar around which the saw chain moves, and a saw drive gear for driving the saw chain around the saw bar.

22. The apparatus of claim 21, wherein the at least one hazard zone centres about the saw drive gear.

23. The apparatus of claim 21, wherein the at least one hazard zone extends through substantially 90° in a plane aligning with the saw bar.

24. The apparatus of claim 21, wherein the at least one hazard zone extends through substantially 30° in a plane substantially lateral to a plane aligning with the saw bar.

25. The apparatus of claim 19, wherein the at least one hazard zone includes a hazard zone projecting from either side of the cutting tool.

26. The apparatus of claim 18, wherein the timber-working device includes a drive mechanism including at least one driven roller configured to control the position of a stem held by the timber-working device, and wherein the at least one hazard zone includes a hazard zone projecting from the timber-working device in at least one direction in which the stem is configured to be driven by the drive mechanism.

27. A timber-working system, comprising:
a timber-working device configured to perform at least one operation having an associated hazard zone;
at least one object tracking device configured to output a wireless signal indicating the location of the object tracking device; and
at least one processor configured to:
receive the wireless signal indicating a location of the object tracking device;
determine the location of the object tracking device relative to the hazard zone of the timber-working device;
determine recommended operation of the timber-working device based at least in part on the location of the object tracking device relative to the hazard zone.
